(19) United States
(12) Patent Application Publication
(10) Pub. No.: US 2018/0148548 A1
(43) Pub. Date: May 31, 2018

(54) RUBBER COMPOSITION FOR GOLF BALLS AND PREPARATION THEREOF

(71) Applicant: Bridgestone Sports Co., Ltd., Tokyo (JP)

(72) Inventor: Tsuyoshi NAKAJIMA, Chichibu-shi (JP)

(73) Assignee: Bridgestone Sports Co., Ltd., Tokyo (JP)

(21) Appl. No.: 15/797,432

(22) Filed: Oct. 30, 2017

(30) Foreign Application Priority Data
Nov. 29, 2016 (JP) 2016-231487

(51) Int. Cl. C08J 3/22; C08L 9/00

(52) U.S. Cl. CPC C08J 3/22; C08J 2401/02; C08J 2309/00; C08L 9/00

(57) ABSTRACT

A rubber composition for golf balls includes (I) a base rubber, (II) an unsaturated carboxylic acid and/or a metal salt thereof, (III) a crosslinking initiator, and (IV) cellulose nanofibers. This rubber composition can further improve the durability of the ball without requiring the use of high-cost fibrous substances as compounding ingredients. Also, the steps in preparation of the golf ball rubber composition can be carried out smoothly and easily, making the rubber composition and its method of preparation economically and industrially advantageous. Moreover, the cellulose nanofibers used in this invention are a plant-based sustainable resource material, and so use of an environmentally friendly golf ball material becomes possible.

### CROSS-REFERENCE TO RELATED APPLICATION

This non-provisional application claims priority under 35 U.S.C. § 119(a) on Patent Application No. 2016-231487 filed in Japan on Nov. 29, 2016, the entire contents of which are hereby incorporated by reference.

### TECHNICAL FIELD

This invention relates to a rubber composition for use in one-piece golf balls and the cores of solid golf balls such as two-piece golf balls and multi-piece golf balls. The invention further relates to a method of preparing such a rubber composition.

### BACKGROUND ART

Various improvements in the compounding of polybutadiene used as a base rubber in golf balls have hitherto been carried out in order to impart excellent resilience and greater core softness. However, when the core is simply made softer, problems arise with the durability to cracking on repeated impact and the feel of the ball when played.

In response, a number of golf ball core compositions containing given amounts of specific organic or inorganic materials have been disclosed as golf ball rubber compositions composed primarily of a base rubber such as polybutadiene. For example, JP-A S59-91973 describes a solid core wherein carbon fibers of at least a given size are included within a rubber material or resin material in order to improve the durability and the feel of the ball at impact. Also, JP-A 2004-351034 describes a golf ball having a good durability in which the propagation of cracks that arise at the ball interior is discouraged by including carbon nanotubes and/or fullerenes in the core and at least one layer encasing the core. In addition, JP-A 2003-180870 teaches the formation of a core using a polymer composition that includes a ternary complex consisting of a rubber component, a polyolefin component and a nylon component in order to provide a golf ball having excellent durability and an excellent feel at impact.

However, such carbon nanotubes, fullerenes, carbon fibers and polyamides are all expensive materials. Moreover, as plastics, they are undesirable from an environmental standpoint. Hence, a desire has existed for improvements to rubber compositions that can provide an alternative to such high-cost compounding ingredients/additives and yet are able to fully impart durability to golf ball cores and the like.

### SUMMARY OF THE INVENTION

It is therefore an object of the present invention to provide a rubber composition for golf balls which does not require the use of compounding ingredients such as high-cost fibrous substances and is able to further improve the durability of the ball. A further object of the invention is to provide a method of preparing such a rubber composition.

As a result of intensive investigations, the inventor has discovered that by adding cellulose nanofibers, particularly a masterbatch obtained by premixing a rubber latex and cellulose nanofibers, as a novel ingredient to a rubber composition that includes as the essential ingredients a base rubber, an unsaturated carboxylic acid and/or metal salt thereof, and a crosslinking initiator, the durability of the crosslinked rubber composition (core) improves, the cellulose nanofibers can be inexpensively procured and can be used without difficulty in kneading operations on golf ball rubber compositions, allowing the production steps to be smoothly and easily carried out, and such addition is economically and industrially advantageous. Moreover, the cellulose nanofibers are plant-based materials, enabling the use of environmentally friendly golf ball materials as a sustainable resource.

Accordingly, in a first aspect, the invention provides a rubber composition for golf balls that includes (I) a base rubber, (II) an unsaturated carboxylic acid and/or a metal salt thereof, (III) a crosslinking initiator, and (IV) cellulose nanofibers.

The cellulose nanofibers serving as component (IV) preferably have an average length of at least 5 μm.

The cellulose nanofibers serving as component (IV) preferably have an average diameter (width) of from 4 to 800 nm.

The rubber composition may include also water.

In a second aspect, the invention provides a method of preparing a rubber composition for golf balls that includes (I) a base rubber, (II) an unsaturated carboxylic acid and/or a metal salt thereof, (III) a crosslinking initiator, and (IV) cellulose nanofibers, which method includes the step of mixing the cellulose nanofibers (IV), in a state dispersed in water or another solvent, with components (I) to (III).

The solvent used in this method is preferably a hydrophilic solvent or a hydrophobic solvent.

The concentration of cellulose nanofibers (IV) dispersed in water or another solvent is preferably at least 0.1 wt %.

In a preferred embodiment, the method of preparation further includes the steps of: preparing a masterbatch by mixing, together with rubber latex, the cellulose nanofibers (IV) dispersed in water or another solvent; and subsequently mixing the masterbatch with components (I) to (III). In this embodiment, the rubber latex is preferably selected from the group consisting of natural rubber latex, BR latex and SBR latex, in which case it is preferable for the method to further include a drying step to evaporate off moisture within the masterbatch.

### ADVANTAGEOUS EFFECTS OF THE INVENTION

The rubber composition for golf balls of the invention is able to further improve the durability of the ball without requiring the use of high-cost fibrous substances as compounding ingredients. Also, the steps in preparation of the golf ball rubber composition can be carried out smoothly and easily, making the rubber composition and its method of preparation economically and industrially advantageous. Moreover, the cellulose nanofibers used in this invention are a plant-based sustainable resource material, and so use of an environmentally friendly golf ball material becomes possible.

### DESCRIPTION OF THE PREFERRED EMBODIMENTS

The objects, features and advantages of the invention will become more apparent from the following detailed description.

The rubber composition for golf balls of the invention includes (I) a base rubber, (II) an unsaturated carboxylic acid and/or a metal salt thereof, (III) a crosslinking initiator, and (IV) cellulose nanofibers.

It is suitable to use, in particular, polybutadiene as the base rubber (I) in the invention. This polybutadiene has a cis-1,4 bond content of at least 60% (here and below, “%” stands for percent by weight), preferably at least 80%, more preferably at least 90%, and most preferably at least 95%. When the cis-1,4 bond content is too low, the resilience decreases. The content of 1,2-vinyl bonds is preferably not more than 2%, more preferably not more than 1.7%, and even more preferably not more than 1.5%.

The polybutadiene has a Mooney viscosity (ML₁₊₄ (100° C.) of preferably at least 30, and more preferably at least 35, with the upper limit being preferably 100 or less, and more preferably 90 or less.

Illustrative examples of the polybutadiene include the following cis-1,4-polybutadiene rubbers available from JSR Corporation: high-cis BR01, BR11, BR02, BR02L, BR02LL, BR730 and BR51.

To obtain a molded and crosslinked rubber composition having a good resilience, the polybutadiene is preferably one synthesized using a rare-earth catalyst or a nickel, cobalt or other group VIII metal compound catalyst.

The polybutadiene accounts for a proportion of the overall rubber composition which is preferably at least 40 wt %, more preferably at least 60 wt %, even more preferably at least 80 wt %, and most preferably at least 90 wt %. The polybutadiene may account for 100 wt % of the base rubber, although it preferably accounts for not more than 98 wt %, and more preferably not more than 95 wt %.

The base rubber may include rubber components other than the above polybutadiene within a range that does not detract from the advantageous effects of the invention. Examples of rubber components other than the foregoing polybutadiene include other polybutadienes, and diene rubbers other than polybutadiene, including styrene-butadiene rubber, natural rubber, isoprene rubber and ethylene-propylene-diene rubber.

The unsaturated carboxylic acid or a metal salt thereof used as component (II) in the invention is exemplified by, without particular limitation, α,β-unsaturated carboxylic acids such as acrylic acid and methacrylic acid, and/or metal salts thereof. Examples of the metal include zinc, sodium, potassium, magnesium, lithium and calcium. Copper is not included. α,β-Unsaturated carboxylic acids having 3 to 8 carbon atoms are especially preferred as the α,β-unsaturated carboxylic acid. Specific examples of α,β-unsaturated carboxylic acids may be suitably selected from the group consisting of acrylic acid, methacrylic acid, ethacrylic acid, itaconic acid, maleic acid and fumaric acid. Alternatively, a metal salt of an α,β-unsaturated carboxylic acid may be suitably used. It is especially preferable for the metal salt to be a zinc salt.

The content of component (II), although not particularly limited, is preferably at least 5 parts by weight, and more preferably at least 15 parts by weight, but preferably not more than 50 parts by weight, and more preferably not more than 45 parts by weight, per 100 parts by weight of the base rubber.

An organic peroxide may be suitably used as the crosslinking initiator serving as component (III) in this invention. Illustrative examples of organic peroxides include 1,1-di(t-butylperoxy)cyclohexane, 1,1-bis-t-butylperoxy-3,3,5-trimethylcyclohexane, dicumyl peroxide, di(t-butylperoxy)-m-diisopropylbenzene and 2,5-dimethyl-2,5-di-t-butylperoxyhexane. These organic peroxides may be of one type used alone, or two or more types may be used in combination.

The content of the organic peroxide, although not particularly limited, may be set to at least 0.1 part by weight, and preferably at least 0.3 part by weight, per 100 parts by weight of the base rubber. The upper limit may be set to not more than 5 parts by weight, and preferably not more than 2 parts by weight.

In the practice of this invention, various inorganic compounds other than the ingredients mentioned above may be suitably included as additional rubber compounding ingredients.

For example, an inorganic filler may be typically compounded with the base rubber. This has the role primarily of adjusting the rubber weight. Illustrative examples of such inorganic fillers include zinc oxide, calcium carbonate, calcium oxide, magnesium oxide, barium sulfate and silica. The use of a metal oxide such as zinc oxide, calcium oxide or magnesium oxide is especially preferred.

As for other optional ingredients in the rubber composition, an organosulfur compound may be included for the purpose of improving the resilience of the molded and crosslinked rubber material. Such organosulfur compounds are exemplified by thiophenols, thionaphthols, halogenated thiophenols and metals salts thereof. Specific examples include pentachlorothiophenol, pentafluorothiophenol, pentabromothiophenol, p-chlorothiophenol and metal salts thereof, especially zinc salts. In this case, the content of the organosulfur compound is preferably at least 0.001 part by weight, and not more than 5 parts by weight, per 100 parts by weight of the base rubber.

Where necessary, an antioxidant may also be included. For example, a compound such as 2,2′-methylenebis(4-methyl-6-tert-butylphenol) may be used. The amount of antioxidant included per 100 parts by weight of the base rubber is preferably at least 0.05 part by weight, and more preferably at least 0.1 part by weight. The upper limit is preferably not more than 3 parts by weight. Illustrative examples include Nocrac NS-6, Nocrac NS-5 and Nocrac NS-30 from Ouchi Shinko Chemical Industry Co., Ltd.

In addition, by directly adding water (or a water-containing material) to the golf ball rubber composition of the invention, the dissolution of organic peroxide during core compounding can be promoted. Golf balls having such a core can achieve a lower spin rate, in addition to which the durability is excellent and changes in resilience over time can be lowered. The water included in the rubber composition is not particularly limited, and may be distilled water or may be tap water. The use of distilled water that is free of impurities is especially preferred. The amount of water included per 100 parts by weight of the base rubber is preferably at least 0.1 part by weight, and more preferably at least 0.3 parts by weight. The upper limit is preferably not more than 5 parts by weight, and more preferably not more than 4 parts by weight.

Next, the cellulose nanofibers (IV) used in the invention are described.

Cellulose nanofibers are obtained from raw materials such as lumber, straw, or plant stems. Because they have a high elastic modulus comparable to that of high-strength fibers such as aramid fibers, they are attracting attention as an inexpensive, high-performance sustainable resource material. The process commonly used to produce cellulose nanofibers involves converting the plant material into pulp (pulping), and additionally carrying out mechanical fibrillating treatment. The pulping method is not particularly limited, although suitable use can be made of a method that mechanically converts plant materials into pulp. The method of carrying out mechanical fibrillating treatment method is not particularly limited; suitable use can be made of, for example, a twin-screw kneading extruder, a high-pressure homogenizer, a media agitating mill, a stone pestle, a grinder, or a vibratory mill.

The cellulose nanofibers have an average length which, from the standpoint of enhancing the durability of the golf ball, is preferably at least 5 μm. Also, the cellulose nanofibers have an average diameter (width) which is preferably from 4 to 800 nm, and more preferably from 4 to 400 nm. The average length and average diameter (width) are values obtained by dispersing the fibers in an ethylene glycol solution and carrying out measurement by the pore electrical resistance method (Coulter Principle).

A commercial product may be used as such cellulose nanofibers.

Cellulose nanofibers available as commercial products are generally provided in a form consisting of the fibers dispersed in water or any of various solvents. The various solvents are exemplified by hydrophilic solvents such as methanol, ethanol and acetone, and hydrophobic solvents such as benzene, toluene, ethyl acetate and dimethylsulfoxide. Cellulose nanofibers that have been prepared as a disperse solution may be directly mixed in this state with the rubber composition, although it is preferable to first prepare a masterbatch of the cellulose nanofibers and then mix this masterbatch with the rubber composition. Specifically, the masterbatch is prepared by mixing a rubber latex into a cellulose nanofiber disperse solution. The concentration of cellulose nanofibers in the masterbatch is preferably at least 0.1 wt %, more preferably at least 0.3 wt %, and even more preferably at least 0.5 wt %. For a good mixing efficiency, the cellulose nanofiber concentration in the masterbatch is preferably not more than 40 wt %, and more preferably not more than 30 wt %.

Next, a rubber latex is mixed into the masterbatch. This rubber latex is exemplified by natural rubber latex, butadiene rubber (BR) latex and styrene-butadiene rubber (SBR) latex. A commercial latex may be used for this purpose. From the standpoint of resilience, the use of a BR latex is preferred.

The method generally used to prepare the masterbatch involves mixing together the cellulose nanofibers and rubber latex, and then removing water or various solvents from the mixture. The mixing method, although not particularly limited, may involve the use of, for example, a homogenizer, a rotary stirring apparatus, a magnetic stirrer or a propeller-type stirrer. The method of removing water or various solvents, although not particularly limited, may involve the use of, for example, oven drying, freeze drying or spray drying. It is also possible to speed up drying by coagulating the rubber latex with an acid. Examples of the acid used at this time include formic acid, acetic acid, hydrochloric acid and sulfuric acid.

The content within the rubber composition of the cellulose nanofibers (IV) used in this invention, both when mixed directly into the rubber composition and when added to the rubber composition following preparation of the above masterbatch, is preferably at least 0.05 part by weight, more preferably at least 0.1 part by weight, and even more preferably at least 0.2 part by weight, per 100 parts by weight of the base rubber such as polybutadiene.

As described above, a molded and crosslinked rubber material can be obtained by using a method similar to that used for conventional golf ball rubber compositions to process a rubber composition containing as the essential ingredients (I) a base rubber, (II) an unsaturated carboxylic acid and/or a metal salt thereof, (III) a crosslinking initiator, and (IV) cellulose nanofibers. An exemplary method entails kneading the above rubber composition with a mixing apparatus such as a roll mill, kneader or Banbury mixer, and then molding the kneaded composition under heat and pressure using a mold. The crosslinking conditions are not particularly limited with regard to temperature and time, although this is preferably carried out for a period of from 10 to 40 minutes at between 100 and 200° C.

The golf ball which includes the above molded and crosslinked rubber material as a structural element may take any of various forms, including, without particular limitation, one-piece golf balls in which the molded and crosslinked rubber material is used directly as the golf ball, two-piece solid golf balls in which the molded and crosslinked rubber material serves as the core and a cover is formed on the surface thereof, multi-piece solid golf balls of three or more pieces in which the molded and crosslinked rubber material serves as the core and a cover of two or more layers is formed thereon, and wound golf balls in which the molded and crosslinked rubber material is used as the center core.

When the molded and crosslinked rubber material is used as a golf ball core, the core has a diameter which varies with the layer structure of the ball. Although not particularly limited, in a three-piece solid golf ball for example, the core diameter is preferably at least 30 mm, and more preferably at least 35 mm, with the upper limit being preferably not more than 41 mm, and more preferably not more than 40 mm. At a core diameter outside of this range, the initial velocity of the ball may decrease and suitable spin properties may not be obtainable.

The core has a deflection under given loading, i.e., a deflection when compressed under a final load of 1,275 N (130 kgf) from an initial load state of 98 N (10 kgf), which has a lower limit of preferably at least 2.0 mm, more preferably at least 2.5 mm, and even more preferably at least 2.8 mm, and an upper limit of preferably not more than 5.0 mm, more preferably not more than 4.7 mm, and even more preferably not more than 4.5 mm. When this core deflection is too small, the feel of the ball at impact may be greatly compromised, or the spin rate may rise excessively, as a result of which the desired distance may not be achieved. On the other hand, when this deflection is too large, a good initial velocity may not be obtained or the durability of the ball may be greatly compromised.

The core has an initial velocity which, although not particularly limited, is preferably at least 76.0 m/s, and more preferably at least 77.0 m/s. Measurement of the core and ball initial velocities is carried out using the measurement apparatus and measurement conditions described subsequently in the “Examples” section of the Specification.

As noted above, the rubber composition is well-suited for use as a golf ball core. In turn, this core is well-suited for use in golf balls where it is encased by a cover of at least one layer. The core may be formed as a single layer or as a plurality of two or more layers. In cases where the cover consists of a plurality of layers, in addition to the outermost layer of the cover, an intermediate layer situated between the outermost layer and the core is also included. Accordingly, the cover can be made a two-layer cover consisting of, in order from the inside, an intermediate layer and an outermost layer. In addition, an envelope layer may be provided between the core and the intermediate layer, in which case the cover can be made a three-layer cover having, in order from the inside, an envelope layer, an intermediate layer and an outermost layer. Numerous dimples are generally formed on the outside surface of the outermost layer of the cover.

The materials making up the respective cover layers are not particularly limited, although various thermoplastic resin materials may be suitably used as the intermediate layer material. The use of an ionomer resin material or a highly neutralized resin material as the intermediate layer material is especially suitable, with the use of an ionomer resin material being preferred.

Commercial products may be used as this resin. Illustrative examples include sodium-neutralized ionomer resins such as Himilan® 1605, Himilan® 1601 and AM 7318 (all products of DuPont-Mitsui Polychemicals Co., Ltd.) and Surlyn® 8120 (E.I. DuPont de Nemours & Co.); zinc-neutralized ionomer resins such as Himilan® 1557, Himilan® 1706 and AM 7317 (all products of DuPont-Mitsui Polychemicals Co., Ltd.); and the products available from E.I. DuPont de Nemours & Co. under the trade names HPF 1000, HPF 2000 and HPF AD1027, as well as the experimental material HPF SEP1264-3. These may be used singly or two or more may be used in combination.

Exemplary materials for the outermost layer of the cover include not only the above-mentioned ionomer resins, but also, from the standpoint of controllability and scuff resistance, polyurethanes. In particular, when using polyurethane as the outermost layer material, a thermoplastic polyurethane elastomer may be employed. A commercial product may be suitably used as this thermoplastic polyurethane elastomer. Illustrative examples include products available from DIC Covestro Polymer Ltd. under the trade name PANDEX and products available from Dainichiseika Color & Chemicals Mfg. Co., Ltd. under the trade name RESAMINE.

From the standpoint of aerodynamic performance, the golf ball which includes the above core generally is provided with numerous dimples on the surface of the outermost layer. Also, a paint film layer is generally formed on the cover surface for the sake of aesthetics, durability and the like. The paint that forms this paint film layer is preferably a two-part curable urethane paint. Such two-part curable urethane paints include a base resin composed primarily of a polyol resin and a curing agent composed primarily of polyisocyanate.

The golf ball has a diameter of not less than 42 mm, preferably not less than 42.3 mm, and more preferably not less than 42.6 mm. The ball diameter is not more than 44 mm, preferably not more than 43.8 mm, even more preferably not more than 43.5 mm, and still more preferably not more than 43 mm. The golf ball weight is preferably not less than 44.5 g, more preferably not less than 44.7 g, even more preferably not less than 45.1 g, and most preferably not less than 45.2 g. The ball weight is preferably not more than 47.0 g, more preferably not more than 46.5 g, and even more preferably not more than 46.0 g.

### EXAMPLES

Working Examples and Comparative Examples are provided below to illustrate the invention, and are not intended to limit the scope thereof.

### Working Examples 1 to 8, Comparative Examples 1 and 2

### Preparation of Cellulose Nanofiber Masterbatch

An aqueous solution of cellulose nanofibers (solids content, 10 wt %) was used to prepare the two different masterbatches shown in Table 1 below: Masterbatch 1 and Masterbatch 2.

First, the aqueous solution of cellulose nanofibers (solids content, 10 wt %), distilled water and BR latex were mixed, in the weights shown in Table 1 below, within a high-speed homogenizing mixer at a speed of 3,000 rpm for 5 minutes, thereby giving mixed solutions. These solutions were spread out into bats, and then dried and solidified within an oven at a temperature of 100° C., giving Masterbatch 1 and Masterbatch 2. The last line in Table 1 shows the cellulose nanofiber concentration following moisture removal.

TABLE 1

| | Masterbatch 1 | Masterbatch 2 |
|---|---|---|
| Aqueous solution of cellulose | 250 | 600 |
| nanofibers (g) | | |
| Distilled water (g) | 525 | 260 |
| BR latex (g) | 225 | 140 |
| Concentration (wt %) | 10 | 30 |

Details on the ingredients in Table 1 are given below.
Aqueous solution of cellulose nanofibers:
   Available from Chuetsu Pulp & Paper Co., Ltd.
   (product having a solids content of 10 wt %; type of tree, broadleaf tree; degree of fibrillation, moderate)
Distilled water: Wako Pure Chemical Industries, Ltd.
BR latex: Nippon A&L Inc.

Next, rubber compositions were prepared by blending the various ingredients shown in Table 2. In Working Examples 1 to 3 and 6 to 8, Masterbatch 1 or Masterbatch 2 that had passed through the above drying step was kneaded with the ingredients shown in the following table. In Working Examples 4 and 5, the aqueous solution of cellulose nanofibers was added directly to the mixing apparatus and kneading was carried out with the ingredients in the table below. The rubber compositions in these Examples were vulcanized for 15 minutes at 157° C. and then passed through a core surface abrasion step, thereby producing cores having a diameter of 38.65 mm.

TABLE 2

| | | | | | | | | | | | Comparative | |
|---|---|---|---|---|---|---|---|---|---|---|---|---|
| | | | Working Example | | | | | | | | Example | |
| | | | 1 | 2 | 3 | 4 | 5 | 6 | 7 | 8 | 1 | 2 |
| Rubber | Polybutadiene rubber | | 55 | 91 | 65 | 100 | 100 | 55 | 91 | 65 | 100 | 100 |
| composition | Zinc oxide | | 4 | 4 | 4 | 4 | 4 | 4 | 4 | 4 | 4 | 4 |
| (pbw) | Barium sulfate | | 12.1 | 12.1 | 12.1 | 5.6 | 5.6 | 5.6 | 5.6 | 5.6 | 12.1 | 5.6 |
| | Antioxidant | | 0.1 | 0.1 | 0.1 | 0.1 | 0.1 | 0.1 | 0.1 | 0.1 | 0.1 | 0.1 |
| | Zinc salt of pentachlorothiophenol | | 0.2 | 0.2 | 0.2 | 0.2 | 0.2 | 0.2 | 0.2 | 0.2 | 0.2 | 0.2 |
| | Unsaturated metal carboxylate | | 29 | 29 | 29 | 46 | 46 | 46 | 46 | 46 | 29 | 46 |
| | Cellulose Nanofiber Masterbatch 1 | | 50 | 10 | | | | 50 | 10 | | | |
| | Cellulose Nanofiber Masterbatch 2 | | | | 50 | | | | | 50 | | |
| | Aqueous solution of cellulose | | | | | 1 | 0.5 | | | | | |
| | nanofibers | | | | | | | | | | | |
| | Distilled water | | | | | | 0.5 | 1 | 1 | 1 | | 1 |
| | Organic peroxide | | 1 | 1 | 1 | 1 | 1 | 1 | 1 | 1 | 1 | 1 |
| Core | Deformation under loading (mm) | | 3.0 | 3.0 | 3.0 | 3.0 | 3.0 | 3.0 | 3.0 | 3.0 | 3.0 | 3.0 |
| | Hardness | Center hardness | 63.1 | 63.5 | 63.0 | 64.0 | 64.1 | 64.0 | 64.2 | 63.7 | 63.2 | 64.0 |
| | profile | Surface hardness | 77.5 | 77.7 | 77.2 | 92.3 | 92.0 | 92.2 | 92.4 | 92.2 | 77.3 | 92.0 |
| | (JIS-C) | Surface hardness − | 14.4 | 14.2 | 14.2 | 28.3 | 27.9 | 28.2 | 28.2 | 28.5 | 14.1 | 28.0 |
| | | Center hardness | | | | | | | | | | |

| | | | | | | | | | | | |
|---|---|---|---|---|---|---|---|---|---|---|---|
| Ball | Deformation under loading (mm) | 2.2 | 2.2 | 2.2 | 2.2 | 2.2 | 2.2 | 2.2 | 2.2 | 2.2 | 2.2 |
| | Durability | 250 | 150 | 320 | 130 | 120 | 200 | 130 | 250 | 100 | 100 |

Details on the ingredients mentioned in the table are given below.
Polybutadiene rubber: Available under the trade name “BR01” from JSR Corporation.
Zinc oxide: Available as “Zinc Oxide Grade 3” from Sakai Chemical Co., Ltd.
Barium sulfate: Available under the trade name “Barico #100” from Hakusui Tech
Antioxidant: Available under the trade name “Nocrac NS-6” from Ouchi Shinko Chemical Industry Co., Ltd.
Zinc salt of pentachlorothiophenol: Available from Wako Pure Chemical Industries, Ltd.
Unsaturated metal carboxylate: Zinc acrylate (Wako Pure Chemical Industries, Ltd.)
Aqueous solution of cellulose nanofibers:
   Available from Chuetsu Pulp & Paper, Ltd. (solids content, 10 wt %)
Distilled water: Available from Wako Pure Chemical Industries, Ltd.)
Organic peroxide: Available under the trade name “Percumyl D” from NOF Corporation

The core hardnesses (center/cross-sectional), deflection and durability were measured for the spherical molded and crosslinked core materials obtained in the respective Examples. The results are presented in Table 2.

Core Deformation under Loading (Deflection)

The core was compressed at 23±1° C. and a speed of 10 mm/s, and the amount of deflection (mm) by the core when subjected to a final load of 1,275 N (130 kgf) from an initial load state of 98 N (10 kgf) was measured. The average value for ten measured cores (N=10) was determined.

### Center and Surface Hardnesses of Core (JIS-C Hardness)

The core center hardness was obtained by cutting the spherical core in half through the center and measuring the hardness at the center of the resulting cross-section. The core surface hardness was obtained by perpendicularly pressing the indenter of a durometer against the surface of the spherical core and measuring the hardness. The JIS-C hardness was measured with the spring-type durometer (JIS-C model) specified in JIS K 6301-1975. The average value for three cores was determined, and this average value was treated as the measured value. These hardnesses are all measured values obtained after holding the core isothermally at 23° C.

Next, using an injection mold, an ionomer resin material was injection-molded over the surface of the core to form an intermediate layer having a thickness of 1.25 mm and a Shore D hardness of 63. The ionomer resin materials used were the ionomer blends Himilan® 1605, Himilan® 1706 and Himilan® 1557, all available from DuPont-Mitsui Polychemicals Co., Ltd.

Next, using another injection mold, a urethane resin material was injection-molded over the above intermediate layer-encased sphere to form an outermost layer having a thickness of 0.8 mm and a Shore D hardness of 47, thereby giving a golf ball. In addition, at the same time as this injection-molding step, numerous dimples in an arrangement common to all the Examples were formed on the surface of the cover. The urethane resin materials used were the urethane compounds Pandex T8283, Pandex T8290 and Pandex T8295, all available under these trade names from DIC Bayer Polymer, Ltd.

The resulting golf balls were evaluated by the following methods for their deformation under specific loading (deflection) and durability. The results are presented in Table 2.

Ball Deformation under Loading (Deflection)

The ball was compressed at 23±1° C. and a speed of 10 mm/s, and the amount of deflection (mm) by the ball when subjected to a final load of 1,275 N (130 kgf) from an initial load state of 98 N (10 kgf) was measured. The average value for ten measured balls (N=10) was determined.

### Durability

The durability of the golf ball was evaluated using an ADC Ball COR Durability Tester produced by Automated Design Corporation (U.S.). This tester fires a golf ball pneumatically and causes it to repeatedly strike two metal plates arranged in parallel. The incident velocity against the metal plates was set to 43 m/s. The number of shots required for the golf ball to crack was measured, and the average value obtained from measurements for ten golf balls (N=10) was determined. In Working Examples 1 to 3, the results are given as numbers relative to an arbitrary value of 100 for the number of shots at which the balls in Comparative Example 1 began to crack. In Working Examples 4 to 8, the results are given as numbers relative to an arbitrary value of 100 for the number of shots at which the balls in Comparative Example 2 began to crack.

As is apparent from Table 2, upon comparing the cellulose nanofiber-containing rubber compositions of Working Examples 1 to 8 with the cellulose nanofiber-lacking rubber compositions of Comparative Examples 1 and 2, the durability of the balls obtained in the Working Examples showed a satisfactory improvement. Also, a higher cellulose nanofiber concentration in the masterbatches resulted in a larger durability improving effect, demonstrating that cellulose nanofibers have a beneficial effect on the ball durability.

Japanese Patent Application No. 2016-231487 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A rubber composition for golf balls, comprising:
(I) a base rubber,
(II) an unsaturated carboxylic acid and/or a metal salt thereof,
(III) a crosslinking initiator, and
(IV) cellulose nanofibers.

2. The rubber composition of claim 1, wherein the cellulose nanofibers serving as component (IV) have an average length of at least 5 μm.

3. The rubber composition of claim 1, wherein the cellulose nanofibers serving as component (IV) have an average diameter (width) of from 4 to 800 nm.

4. The rubber composition of claim 1, further comprising water.

5. A method of preparing a rubber composition for golf balls that includes (I) a base rubber, (II) an unsaturated carboxylic acid and/or a metal salt thereof, (III) a crosslinking initiator, and (IV) cellulose nanofibers, which method comprises the step of mixing the cellulose nanofibers (IV), in a state dispersed in water or another solvent, with components (I) to (III).

6. The method of claim 5, wherein the solvent is a hydrophilic solvent or a hydrophobic solvent.

7. The method of claim 5, wherein the concentration of cellulose nanofibers (IV) dispersed in water or another solvent is at least 0.1 wt %.

8. The method of claim 5 which further comprises the steps of: preparing a masterbatch by mixing, together with rubber latex, the cellulose nanofibers (IV) dispersed in water or another solvent; and subsequently mixing the masterbatch with components (I) to (III).

9. The method of claim 8, wherein the rubber latex is selected from the group consisting of natural rubber latex, BR latex and SBR latex.

10. The method of claim 9, further comprising a drying step to evaporate off moisture within the masterbatch.
